(19) United States
(12) Patent Application Publication
(10) Pub. No.: US 2016/0167077 A1
(43) Pub. Date: Jun. 16, 2016

(54) Pneumoacoustic atomizer of liquids

(71) Applicant: Andrey Nikolaevich Dubrovsky, Moscow (RU)

(72) Inventor: Andrey Nikolaevich Dubrovsky, Moscow (RU)

(73) Assignee: Advanced Plasma Solutions Inc., Malvern, PA (US)

(21) Appl. No.: 14/907,303

(22) PCT Filed: Aug. 15, 2013
(86) PCT No.: PCT/RU2013/000706

§ 371 Date: Jan. 25, 2016

(30) Foreign Application Priority Data
Jul. 26, 2013 (RU) 2013134992

(51) Int. Cl. B05B 17/06

(52) U.S. Cl. CPC B05B 17/06

(57) ABSTRACT

The invention refers to devices which utilize periodic blast waves for dispersion of liquids, when these waves are created in the supersonic gas jet upon its slowing down by the hollow resonator.

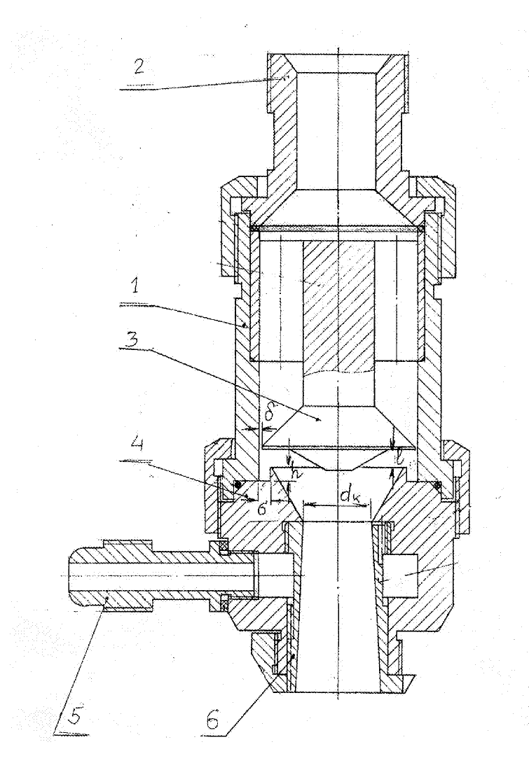

The technical outcome of the invention is the increased dispersity of the produced drops.

The technical result is achieved by the installation of the resonator inside the body of the pneumoacoustic atomizer of liquids, which create (at the distance l from the deflector) the groove which width is σ and the depth is h. The internal part of the resonator is shaped as the conical funnel of the outlet diameter dₖ. Diffusion element has been attached to the conical funnel. The inlet channel for liquids was made as the nipple. The diameter of the critical cross section has been selected based on the condition providing that one of the lateral resonances must be obtained at the operational frequency of the gas jet generator. Diffusion element is made as the auger swirler, the diameter of the critical cross section was selected based on terms providing that dₖ=αₘₙλ/π, where αmn represents the roots of the equation Y₁ (αₘₙ)=0; Y₁ is Bessel function of the 1^{st} order and λ is the length of the wave of vibrations generated in the pneumoacoustic atomizer of liquids.

1 unreliant point of invention 2 reliant points of invention 1 illustration

This invention refers to devices which utilize periodic blast waves to atomize liquids. Waves are created in the supersonic gas jets when they are slowed down by the hollow resonator.

We know the pneumoacoustic atomizer embedding a resonator, gas and water nozzles, a bar, mounted with the gap towards the gas nozzle. The gap size has been selected as δ= =(0.03-0.055)λ, and the resonator depth h=operational frequency. Russian Federation Patent No 2130328, MΠK B05B7/06, 1998: These parameters of the circular gap δ and the resonator depths h are recommended only for devices using the generation frequencies of less than 30 KHz, which are not (in the bar atomizers) under the influence of the bar border layer. In order to get the median size of drops less than 50 um it is necessary to have frequencies over 30 KHz.

We know the pneumoacoustic atomizer of liquids embedding the cylindrical body with the central hole and the central bar inserted into the central hole, which part protrudes from the cylindrical body. It has also the inlet gas channel. The above mentioned cylindrical body has the inlet channel for liquids, liquid circular chamber connected to the said inlet channel for liquids, nozzle for liquids connected to the liquid circular chamber and the gas nozzle, embracing the central bar. The resonator is mounted on the protruding part of the central bar. Its working surface faces the gas nozzle. The said gas and liquid nozzles are coaxially installed. The liquid nozzle is located further on along the radius of the central axis line of the cylindrical body, and the gas nozzle is made as the conical and converging. The cylindrical body has the gas chamber, located before the gas nozzle and adjacent to the central bar surface. The above mentioned central bar has the end-to-end gas channels tying the inlet gas channel (made as a solid device) to the gas chamber. The inlet channel for liquids locates at the periphery of the end face of the cylindrical body and stretches in the direction of axes. Nozzle for liquids is made as the end-to-end liquid channels within the cylindrical body; they are connected to the liquid circular chamber with the possibility to direct jets of liquids to the area of spraying. Here, the liquids are subjected to the impact of blast waves and the inclination angle of the internal walls of the gas nozzle (as measured from the vertical axis) equals to 50-80°. The diameter dₖ of the gas chamber, the diameter dₛ of the central bar and the diameter dₙ of the gas nozzle are bounded by the ratio (d²ₖ−d²ₛ)/(d²ₙ−d²ₛ)=5-30.

End-to-end liquid channels are equally distributed along the periphery of the liquid circular chamber or along the central bar. The cylindrical body is equipped with the feedwell, embracing the above mentioned body, and the liquid circular chamber and end-to-end liquid channels are made by the grooves in the cylindrical body and limited by the feedwell internal surface. Russian Federation Patent No 2232647, MΠK: B05B17/04, 2002. The atomizer defect—upon contraction ratio m=5÷30, the pressure in gas channels drops and the acoustic efficiency of the atomizer decreases.

We know the pneumoacoustic atomizer of liquids which has the nozzle body, bar emitter placed inside it, the resonator and the concentrical nozzle, installed with the gap above the nozzle body. The nozzle has been hydraulically tied with the liquid supply system. The devices differ by the location of the bar emitter, which is installed within the nozzle body, and it has possibility to rotate respectfully to its longitudinal axis which bears the blades. The reflecting ring plate, placed in the resonator cavity, was made with the lateral slits. Russian Federation Patent No 2260478, MΠK: B05B17/04, 2005. Atomizer's defect occurs due to installation of the resilient element inside the resonator, which is guarded by the protecting washer. It results in the periodical change of the resonator depth determining the generation frequency and it makes the impact on the stability of radiation and dispergation process.

We know the pneumoacoustic atomizer of liquids that has the cylindrical body with the central hole and inlet gas channel. The central bar is inserted into the central hole and it has the part protruding from the cylindrical body. The body has the inlet channel for liquids, liquid circular chamber connected to the inlet channel for liquids and the liquid nozzle connected to liquid circular chamber. The gas nozzle embraces the central bar; the ring-like resonator is mounted on the protruding part of the central bar, which working surface faces the gas nozzle. The gas nozzle and liquid nozzle are coaxial. The liquid nozzle sits further on along the axis line of the cylindrical body. The feedwell embraces the cylindrical body. The liquid circular chamber and the nozzle for liquids are created by grooves in the cylindrical body limited by the internal surface of the feedwell.

Inlet gas nozzle is made cylindrical but the central bar is profiled. The part located inside the nozzle has the conical shape with the divergence angle of 45-80°, the part behind the nozzle edge is cylindrical. The place for convergence of cylindrical and conical parts of the bar is located at the nozzle edge. The inlet channel for liquids was made as the nipple mounted on the external surface of the feedwell and connected with the liquid circular chamber. Russian Federation Patent No 2467807, MΠK: B05B17/04, 2012.

Well known is also the slit-type pneumatic atomizer including the base, container, air pipes and hydraulic drives, surge tank, feeding pipe and jet making device with the top and bottom plate and gasket between them. The jet making device has the liquid distributor and the top and bottom plates are shaped as rings. The top plate has grooves to place the feeding pipes in them. The pipes are closed by the plate lid and connected to liquid distributor. Jet making device has the flat air chamber, at least, with three slit-like nozzles and the outlet holes are provided over them for, at least, three feeding pipes. Russian Federation Patent No 2467807, MΠK: B05B7/00, 2013. The deficiency of the bar atomizer of liquid is the difficulties in obtaining the drops less than 60 um in the narrow flare of gas/liquid mixture since there emerge angle-shock waves in the circular jets together with the normal shock wave before the resonator. The angle-shock waves change its position at the cylindrical section of the bar in the result of the current sharp twist in the zone where the Mach number is equal to one.

The technical result of the invention is the increase of the dispersion degree of the produced drops.

The technical result is achieved when in the pneumoacoustic atomizer of liquids embedding the body, gas inlet nipple coaxially installed towards the deflector, making the circular slit inside the body with the width δ, the resonator is installed inside the body making the groove with the width of δ and the depth h at the distance l from the deflector. The internal part of the resonator has been shaped as the conical funnel of the outlet diameter dₖ. The diffuser element has been attached to the conical funnel and the inlet channel for liquids was made as nipple. The diameter of the critical cross section was selected based on the term of receiving of one of the lateral resonances at the operational frequency of the gas jet generator. The diffuser element was made as the auger swirler and the diameter of the critical cross section was selected based on conditions according to which dₖ=αₘₙλ/π, where αₘₙ indicates the roots of the equation Y₁ (πₘₙ)=0; Y₁ is the Bessel's function of the first order, λ is the length of the wave of vibrations generated within the pneumoacoustic atomizer of liquids.

The main idea of the invention has been explained on the drawing where 1 is the body, 2—gas inlet nipple, 3—nozzle deflector, 4—ring-like resonator, 6—width of the circular slit in the body 1, σ is the width of the groove in the ring-like resonator, h is the depth of the ring-like resonator, dₖ is the outlet diameter of the conical funnel, 5—nipple and 6 is biconic head.

Operational gas with the pressure P exceeding the critical P_{cr} enters the body of the pneumoacoustic atomizer of liquids 1 through the gas nipple 2. Gas (through the circular slit between the internal wall of the body 1 and deflector 3) flows out into the working zone of Hartmann generator making the first drum of the supersonic jet which has the system of angle-shot waves. When it is slowed down by the resonator 4 the normal direct wave occurs creating the subsonic zone.

In the area stretching till the bottom of the resonator 4 and representing the quarter of the wave resonator with one soft (wave) and one rigid (bottom) borders the agitation of the certain frequency may be possible and the blast waves may appear through the biconic head and into the zone of supply of liquid to be atomized.

The vibrations frequency may be determined by the equation:

$$f = \frac{0 , 029 {{C}_{o} ( P - {P}_{κ p} )}^{0 , 11}}{δ \overline{{( \overline{hl} )}^{0 , 36} {( \overline{σ} G )}^{0 , 4}}}$$

Here Cₒ is the speed of sound in the utilized gas, G is the parameter of curvature (G=δ/d_{c}, d_{c}—deflector diameter), hyphens above indices h, l and σ mean their standardizing to the width of the nozzle slit δ, and those above P and P_{cr}-standardizing towards the environmental pressure.

Amplitude of oscillation, developing in the limited space, depends to the high extent on the load with which Hartmann generator works; in this case, it is the diffuser part of the biconic head 6.

In order to coordinate the generator operations with the outlet part of the atomizer it is necessary to have the diameter of the cross section dₖ corresponding to one of the lateral resonances which frequencies are determined by the equation

$${f}_{mn} = \frac{{α}_{mn} {C}_{o}}{π {d}_{k}} ;$$

where Cₒ is the speed of sound in the utilized gas: m=0, 1, 2 . . . ; n=0, 1, 2 . . . ; αₘₙ—roots of the equation Y₁ (αₘₙ)=0; Y₁—Bessel's function of the 1^{st} order. For example, the first symmetric resonance corresponds to α₁₀=1.84.

In the place of convergence of the convergent-divergent parts of the biconic head either symmetric or asymmetric lateral resonances are used determined by the factors αₘₙ; which concrete values are shown in the Table:

| | n | | |
|---|---|---|---|
| m | 0 | 1 | 2 |
| 0 | 0 | 3.8 | 7.0 |
| 1 | 1.84 | 5.3 | 8.54 |
| 2 | 3.05 | 6.7 | 9.9 |
| 3 | 4.2 | 8.0 | 11.3 |

Biconic head diameter may be defined from the following:

dₖ=βλ, where: β=αₘₙ/π, and λ is the length of the wave of vibrations generated in the pneumoacoustic atomizer of liquids. Or from the following term:

dₖ=αₘₙλ/π

So if fmn is close to (±5%) generation frequency f, the frequency is “captured” within the wide range of operational pressure, and the level of the acoustic vibrations grows by 16-20 dB. When the liquid is supplied through head 6 made as the auger swirler, the outcome of the small fractions increases by 20-30%.

1. Pneumoacoustic atomizer of liquids embedding the body, gas inlet nipple, deflector installed coaxially with the nipple, which make the circular slit inside the body of the width δ, differs from others by the resonator making the groove with the width σ and the depth h at the distance l from the deflector. The internal part of the resonator is made as the conical funnel with the outlet diameter dₖ. Diffusion element has been attached to the conical funnel and the inlet channel for liquids has been made as the nipple. The diameter of the critical cross section was selected based on the condition allowing to receive one of the resonances at the operational frequency of the gas jet generator.

2. Pneumoacoustic atomizer of liquids as stated in paragraph 1 differs by the diffusion element made as the auger swirler.

3. Pneumoacoustic atomizer of liquids, as stated in paragraph 1, differs by the diameter of the critical cross section selected based on the condition that:
dₖ=αₘₙλ/π, where αₘₙ means the roots of equation Y₁ (αₘₙ)=0;
Y₁ is Bessel's function of the 1^{st} order, λ is the length of the wave of vibrations generated in the pneumoacoustic atomizer of liquids.
